(19) United States
(12) Patent Application Publication
(10) Pub. No.: US 2012/0249258 A1
(43) Pub. Date: Oct. 4, 2012

(54) ELECTRONIC COMPONENT

(75) Inventor: Hiroyuki SASAKI, Nagaokakyo-shi (JP)

(73) Assignee: Murata Manufacturing Co., Ltd., Nagaokakyo-shi (JP)

(21) Appl. No.: 13/430,735

(22) Filed: Mar. 27, 2012

(30) Foreign Application Priority Data
Mar. 29, 2011 (JP) 2011-071314

(51) Int. Cl. H01P 5/10

(52) U.S. Cl. 333/26; 333/219

(57) ABSTRACT

In an electronic component, a first resonator includes a first quarter-wave strip line disposed on a dielectric layer and a second quarter-wave strip line disposed on another dielectric layer, the first and second quarter-wave strip lines being interdigitally coupled to each other. A second resonator includes a third quarter-wave strip line disposed on a dielectric layer and a fourth quarter-wave strip line disposed on another dielectric layer, the third and fourth quarter-wave strip lines being interdigitally coupled to each other. The first quarter-wave strip line and the third quarter-wave strip line are electromagnetically coupled to each other and are disposed on different dielectric layers. The second quarter-wave strip line and the fourth quarter-wave strip line are electromagnetically coupled to each other.

### BACKGROUND OF THE INVENTION

1. Field of the Invention

The present invention relates to electronic components and, in particular, to an electronic component that converts an unbalanced signal to a balanced signal.

2. Description of the Related Art

An example of a known electronic component is a filter described in Japanese Unexamined Patent Application Publication No. 2007-180684. FIG. 5 is a perspective view of a filter 500 described in Japanese Unexamined Patent Application Publication No. 2007-180684.

As illustrated in FIG. 5, the filter 500 includes an input resonator 501 and an output resonator 502. The input resonator 501 includes quarter-wave strip lines 511 and 512. The quarter-wave strip lines 511 and 512 are interdigitally coupled to each other. The output resonator 502 includes quarter-wave strip lines 521 and 522. The quarter-wave strip lines 521 and 522 are interdigitally coupled to each other. The quarter-wave strip line 511 and the quarter-wave strip line 521 are connected to each other with a connection conductor 510A. The quarter-wave strip line 512 and the quarter-wave strip line 522 are connected to each other with a connection conductor 510B. In the filter 500 having the above-described configuration, when an unbalanced signal is input to the quarter-wave strip line 511, a balanced signal is output from the quarter-wave strip lines 521 and 522.

It is difficult to individually adjust the degree of coupling between the quarter-wave strip lines 511 and 512 and the degree of coupling between the quarter-wave strip lines 521 and 522 in the filter 500 described in Japanese Unexamined Patent Application Publication No. 2007-180684. More specifically, the quarter-wave strip lines 511 and 521 are disposed on the same dielectric layer, and the quarter-wave strip lines 512 and 522 are disposed on the same dielectric layer. Thus, if the number of dielectric layers between the dielectric layer on which the quarter-wave strip lines 511 and 521 are disposed and the dielectric layer on which the quarter-wave strip lines 512 and 522 are disposed is adjusted, the distance between the quarter-wave strip lines 511 and 512 and the distance between the quarter-wave strip lines 521 and 522 are changed. As a result, the degree of coupling between the quarter-wave strip lines 511 and 512 and the degree of coupling between the quarter-wave strip lines 521 and 522 are changed.

### SUMMARY OF THE INVENTION

Accordingly, preferred embodiments of the present invention provide an electronic component in which the degrees of coupling between a plurality of resonators each including a plurality of quarter-wave strip lines are individually adjustable.

According to a preferred embodiment of the present invention, an electronic component to convert an unbalanced signal to a balanced signal includes a laminated body in which a plurality of dielectric layers are stacked in a stacking direction, a first resonator, and a second resonator. The first resonator includes a first quarter-wave strip line and a second quarter-wave strip line interdigitally coupled to the first quarter-wave strip line. The first quarter-wave strip line is disposed on one of the plurality of dielectric layers, the second quarter-wave strip line is disposed on another one of the plurality of dielectric layers, the dielectric layer on which the second quarter-wave strip line is disposed is positioned on one side in the stacking direction with respect to the dielectric layer on which the first quarter-wave strip line is disposed. The second resonator includes a third quarter-wave strip line and a fourth quarter-wave strip line interdigitally coupled to the third quarter-wave strip line. The third quarter-wave strip line is disposed on one of the plurality of dielectric layers, the fourth quarter-wave strip line is disposed on another one of the plurality of dielectric layers, the dielectric layer on which the fourth quarter-wave strip line is disposed is positioned on one side in the stacking direction with respect to the dielectric layer on which the third quarter-wave strip line is disposed. The first quarter-wave strip line and the third quarter-wave strip line are electromagnetically coupled to each other, and the dielectric layer on which the first quarter-wave strip line is disposed and the dielectric layer on which the third quarter-wave strip line is disposed are different. The second quarter-wave strip line and the fourth quarter-wave strip line are electromagnetically coupled to each other.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an external perspective view of an electronic component according to a preferred embodiment of the present invention.

FIG. 2 is an exploded perspective view of a laminated body of the electronic component illustrated in FIG. 1.

FIG. 3 is an exploded perspective view of a laminated body of an electronic component according to a first variation of a preferred embodiment of the present invention.

FIG. 4 is an exploded perspective view of a laminated body of an electronic component according to a second variation of a preferred embodiment of the present invention.

FIG. 5 is a perspective view of a filter described in Japanese Unexamined Patent Application Publication No. 2007-180684.

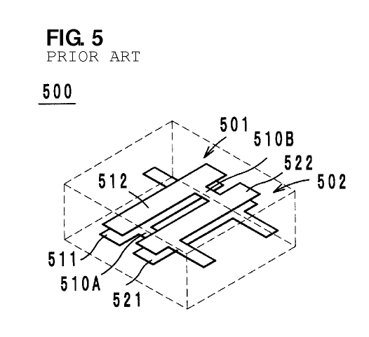

### DETAILED DESCRIPTION OF THE PREFERRED EMBODIMENTS

A configuration of an electronic component according to preferred embodiments of the present invention is described below with reference to the drawings.

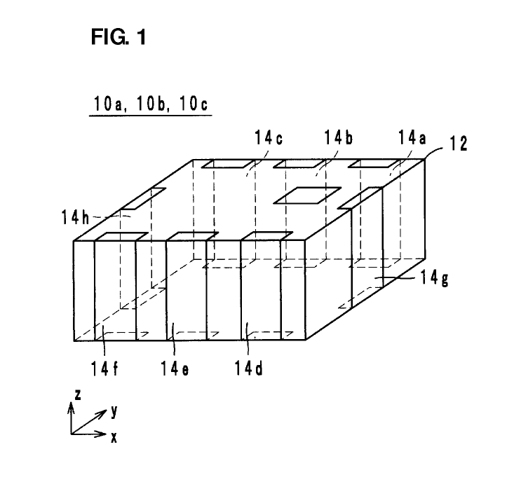

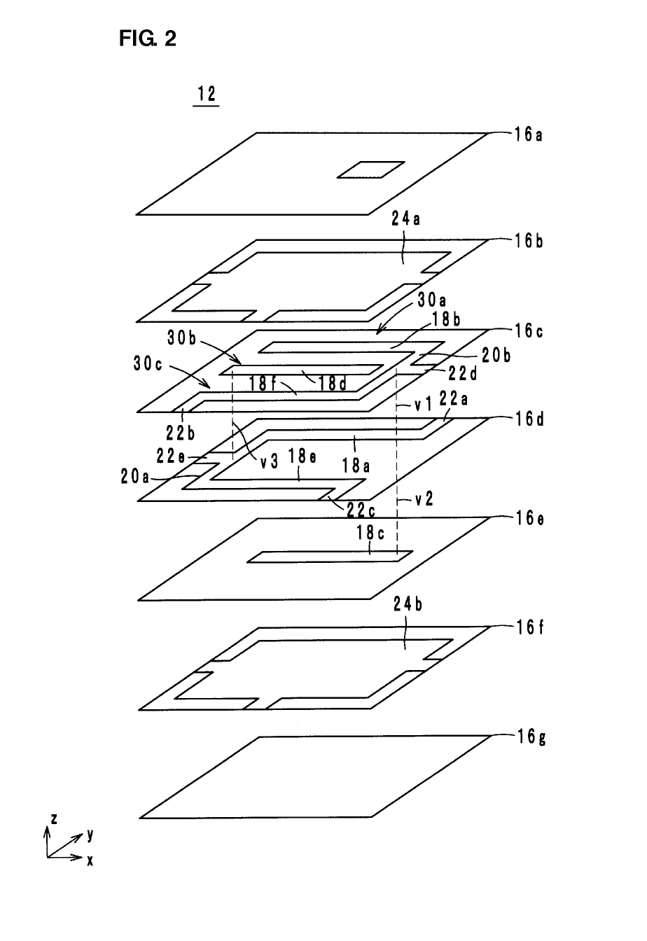

An electronic component according to a preferred embodiment of the present preferred embodiment preferably is a balance filter. The balance filter can be used in a tuner of a cellular phone and can convert an unbalanced signal received by an antenna to a balanced signal and output the balanced signal to a high-frequency IC at the subsequent stage, for example. FIG. 1 is an external perspective view of an electronic component 10a according to a preferred embodiment of the present invention. FIG. 2 is an exploded perspective view of a laminated body 12 of the electronic component 10a illustrated in FIG. 1. In the following description, the stacking direction of the electronic component 10a is defined as the z-axis direction and, when seen from the z-axis direction, the direction extending along the long sides of the electronic component 10a is defined as the x-axis direction and the direction extending along the short sides of the electronic component 10a is defined as the y-axis direction. The x-axis direction, y-axis direction, and z-axis direction are perpendicular or substantially perpendicular to one another.

As illustrated in FIGS. 1 and 2, the electronic component 10a includes the laminated body 12, external electrodes (14a to 14h), connection conductors 20 (20a, 20b), drawn conductors 22 (22a to 22e), ground conductors 24 (24a, 24b), resonators 30 (30a to 30c), and via-hole conductors v (v1 to v3).

As illustrated in FIG. 2, the laminated body 12 preferably includes dielectric layers 16a to 16g stacked in this order from the positive side toward the negative side in the z-axis direction and preferably has an approximately rectangular parallelepiped shape. Each of the dielectric layers 16 can be a dielectric layer having an approximately rectangular shape (e.g., low temperature co-fired ceramic), for example.

Each of the external electrodes 14 (14a to 14h) is disposed on the surface of the laminated body 12. Specifically, the external electrodes 14a to 14c are disposed on the positive-side lateral surface in the y-axis direction and arranged in this order from the positive side toward the negative side in the x-axis direction, as illustrated in FIG. 1. The external electrodes 14d to 14f are disposed on the negative-side lateral surface in the y-axis direction and arranged in this order from the positive side toward the negative side in the x-axis direction, as illustrated in FIG. 1. The external electrode 14g is disposed on the positive-side end surface in the x-axis direction. The external electrode 14h is disposed on the negative-side end surface in the x-axis direction. Each of the external electrodes 14 can be formed by application of a nickel coating and a tin coating to a silver background electrode, for example.

As illustrated in FIG. 2, the resonator 30a includes quarter-wave strip lines 18a and 18b. The quarter-wave strip line 18a is disposed on the dielectric layer 16d, extends along the x-axis direction, and can be a linear copper conductive layer, for example. The quarter-wave strip line 18b is disposed on the dielectric layer 16c, which is on the positive side in the z-axis direction with respect to the dielectric layer 16d, extends along the x-axis direction, and can be a linear copper conductive layer, for example. The quarter-wave strip lines 18a and 18b face each other such that the dielectric layer 16c is disposed therebetween and are thus electromagnetically coupled to each other. Each of the quarter-wave strip lines 18a and 18b has a length of approximately one quarter of the wavelength of a signal having the operating frequency of the electronic component 10a.

As illustrated in FIG. 2, the resonator 30b includes quarter-wave strip lines 18c and 18d and is disposed on the negative side in the y-axis direction with respect to the resonator 30a. The quarter-wave strip line 18c is disposed on the dielectric layer 16e, extends along the x-axis direction, and can be a linear copper conductive layer, for example. The quarter-wave strip line 18d is disposed on the dielectric layer 16c, which is on the positive side in the z-axis direction with respect to the dielectric layer 16e, extends along the x-axis direction, and can be a linear copper conductive layer, for example. The quarter-wave strip lines 18c and 18d face each other such that the dielectric layers 16c and 16d are disposed therebetween and are thus electromagnetically coupled to each other. Each of the quarter-wave strip lines 18c and 18d has a length of approximately one quarter of the wavelength of a signal having the operating frequency of the electronic component 10a.

As illustrated in FIG. 2, the resonator 30c includes quarter-wave strip lines 18e and 18f and is disposed on the negative side in the y-axis direction with respect to the resonator 30b. The quarter-wave strip line 18e is disposed on the dielectric layer 16d, extends along the x-axis direction, and can be a linear copper conductive layer, for example. The quarter-wave strip line 18f is disposed on the dielectric layer 16c, which is on the positive side in the z-axis direction with respect to the dielectric layer 16d, extends along the x-axis direction, and can be a linear copper conductive layer, for example. The quarter-wave strip lines 18e and 18f face each other such that the dielectric layer 16c is disposed therebetween and are thus electromagnetically coupled to each other. Each of the quarter-wave strip lines 18e and 18f has a length of approximately one quarter of the wavelength of a signal having the operating frequency of the electronic component 10a.

The quarter-wave strip lines 18a and 18e are disposed on the same dielectric layer 16d, whereas the quarter-wave strip line 18c is disposed on the dielectric layer 16e, which is different from the dielectric layer 16d, on which the quarter-wave strip lines 18a and 18e are disposed. Therefore, the quarter-wave strip lines 18a and 18c are electromagnetically coupled to each other. The quarter-wave strip lines 18a and 18c and the quarter-wave strip lines 18c and 18e are electromagnetically coupled to each other.

The quarter-wave strip lines 18b, 18d, and 18f are disposed on the dielectric layer 16c such that they substantially coincide with each other in the y-axis direction. Therefore, the quarter-wave strip lines 18b and 18d are electromagnetically coupled to each other. The quarter-wave strip lines 18d and 18f are electromagnetically coupled to each other.

The connection conductor 20a is disposed on the dielectric layer 16d, extends in the y-axis direction, and can be a linear copper conductive layer, for example. The positive-side end of the connection conductor 20a in the y-axis direction is connected to the negative-side end of the quarter-wave strip line 18a in the x-axis direction. The negative-side end of the connection conductor 20a in the y-axis direction is connected to the negative-side end of the quarter-wave strip line 18e in the x-axis direction.

The connection conductor 20b is disposed on the dielectric layer 16c, extends in the y-axis direction, and can be a linear copper conductive layer, for example. The positive-side end of the connection conductor 20b in the y-axis direction is connected to the positive-side end of the quarter-wave strip line 18b in the x-axis direction. The negative-side end of the connection conductor 20b in the y-axis direction is connected to the positive-side end of the quarter-wave strip line 18f in the x-axis direction. Therefore, the quarter-wave strip lines 18b and 18f are electrically connected to each other.

The via-hole conductors v1 and v2 pass through the dielectric layers 16c and 16d along the z-axis direction and define one via-hole conductor by being connected to each other. Each of the via-hole conductors v1 and v2 can be made of copper, for example. The positive-side end of the via-hole conductor v1 in the z-axis direction is connected to the connection conductor 20b. The negative-side end of the via-hole conductor v2 in the z-axis direction is connected to the positive-side end of the quarter-wave strip line 18c in the x-axis direction. Therefore, the quarter-wave strip lines 18b, 18c, and 18f are electrically connected to each other.

The via-hole conductor v3 passes through the dielectric layer 16c along the z-axis direction and can be made of copper, for example. The positive-side end of the via-hole conductor v3 in the z-axis direction is connected to the negative-side end of the quarter-wave strip line 18d in the x-axis direction. The negative-side end of the via-hole conductor v3 in the z-axis direction is connected to the connection conductor 20a. Therefore, the quarter-wave strip lines 18a, 18d, and 18e are electrically connected to each other.

The drawing conductor 22a is disposed on the dielectric layer 16d, connected to the positive-side end of the quarter-wave strip line 18a in the x-axis direction, and drawn to the long side of the dielectric layer 16d on the positive side in the y-axis direction. The drawn conductor 22a is connected to the external electrode 14a. The drawn conductor 22a can be made of copper, for example.

The drawn conductor 22b is disposed on the dielectric layer 16c, connected to the negative-side end of the quarter-wave strip line 18f in the x-axis direction, and drawn to the long side of the dielectric layer 16c on the negative side in the y-axis direction. The drawn conductor 22b is connected to the external electrode 14f. The drawn conductor 22b can be made of copper, for example.

The drawn conductor 22c is disposed on the dielectric layer 16d, connected to the positive-side end of the quarter-wave strip line 18e in the x-axis direction, and drawn to the long side of the dielectric layer 16d on the negative side in the y-axis direction. The drawn conductor 22c is connected to the external electrode 14d. The drawn conductor 22c can be made of copper, for example.

The drawn conductor 22d is disposed on the dielectric layer 16c, connected to the connection conductor 20b, and drawn to the short side of the dielectric layer 16c on the positive side in the x-axis direction. The drawn conductor 22d is connected to the external electrode 14g. The drawn conductor 22d can be made of copper, for example.

The drawn conductor 22e is disposed on the dielectric layer 16d, connected to the connection conductor 20a, and drawn to the short side of the dielectric layer 16d on the negative side in the x-axis direction. The drawn conductor 22e is connected to the external electrode 14h. The drawn conductor 22e can be made of copper, for example.

The ground conductor 24a is disposed on the dielectric layer 16b, has an approximately rectangular shape, and can be a copper conductive layer, for example. The ground conductor 24a is connected to the external electrodes 14e, 14g, and 14h by being drawn to the both short sides of the dielectric layer 16b in the x-axis direction and the long side of the dielectric layer 16b on the negative side in the y-axis direction.

The ground conductor 24b is disposed on the dielectric layer 16f, has an approximately rectangular shape, and can be a copper conductive layer, for example. The ground conductor 24b is connected to the external electrodes 14e, 14g, and 14h by being drawn to the both short sides of the dielectric layer 16f in the x-axis direction and the long side of the dielectric layer 16f on the negative side in the y-axis direction.

In the electronic component 10a having the above-described configuration, the external electrodes 14e, 14g, and 14h are grounded, the external electrode 14a serves as the input terminal (unbalanced terminal), the external electrodes 14d and 14f serve as the output terminals (balanced terminals), and thus, the electronic component 10a is used as a balance filter. The quarter-wave strip lines 18a and 18b are interdigitally coupled to each other. The quarter-wave strip lines 18c and 18d are interdigitally coupled to each other. The quarter-wave strip lines 18e and 18f are interdigitally coupled to each other.

Furthermore, the quarter-wave strip lines 18a and 18c are interdigitally coupled to each other. The quarter-wave strip lines 18c and 18e are interdigitally coupled to each other. The quarter-wave strip lines 18b and 18d are interdigitally coupled to each other. The quarter-wave strip lines 18d and 18f are interdigitally coupled to each other.

Interdigital coupling is described below using coupling between the quarter-wave strip lines 18a and 18b as an example. The negative-side end of the quarter-wave strip line 18a in the x-axis direction is grounded (short-circuited), and the positive-side end of the quarter-wave strip line 18a in the x-axis direction is open. The negative-side end of the quarter-wave strip line 18b in the x-axis direction is open, and the positive-side end of the quarter-wave strip line 18b in the x-axis direction is grounded (short-circuited). Such a state in which the open end of one of the two quarter-wave strip lines 18 and the short-circuited end of the other one of the quarter-wave strip lines 18 are arranged alternately is called interdigital coupling.

In the above-described electronic component 10a, an unbalanced signal is input to the quarter-wave strip line 18a through the external electrode 14a. Then, a balanced signal in the frequency range corresponding to the degree of coupling between the quarter-wave strip lines 18 is output from the quarter-wave strip lines 18e and 18f through the external electrodes 14b and 14c.

A non-limiting example of method of producing the electronic component 10a is described below with reference to FIGS. 1 and 2.

First, ceramic green sheets that are to form the dielectric layers 16 are prepared. Next, the via-hole conductors v1 to v3 are formed in each of the ceramic green sheets that are to form the dielectric layers 16c and 16d. In forming the via-hole conductors v1 to v3, the ceramic green sheets that are to form the dielectric layers 16c and 16d are radiated with a laser beam to form via holes. Then, the via holes are filled with conductive paste, such as copper paste, by, for example, application by printing.

Next, conductive paste, such as one predominantly composed of copper, is applied to the surface of each of the ceramic green sheets that are to form the dielectric layers 16b to 16f by, for example, screen printing to form the quarter-wave strip lines 18, connection conductors 20, drawn conductors 22, and ground conductors 24. At the time of formation of the quarter-wave strip lines 18, connection conductors 20, drawn conductors 22, and ground conductors 24, the via holes may be filled with the conductive paste.

Next, the ceramic green sheets are stacked. Specifically, the ceramic green sheets that are to form the dielectric layers 16a to 16g are stacked and are pressed and bonded one by one such that they are arranged in this order from the positive side to the negative side in the z-axis direction. With the above-described steps, the mother laminated body is formed. This mother laminated body is firmly pressed and bonded by, for example, hydrostatic pressing.

Next, the mother laminated body is cut with a cutter to obtain the laminated body 12 having predetermined dimensions. After that, this unfired laminated body 12 is subjected to a binder removing process and a firing process.

With the above-described steps, the fired laminated body 12 is obtained. The laminated body 12 is chamfered by barreling.

Lastly, silver conductive paste is applied to the surface of the laminated body 12 to form the ground electrodes. In addition, a nickel coating and a tin coating are applied to the surface of the ground electrodes to form the external electrodes 14. Through the above-described steps, the electronic component 10a illustrated in FIGS. 1 and 2 is completed.

According to the electronic component 10a having the above-described configuration, the degree of coupling between the quarter-wave strip lines 18a and 18b and that between the quarter-wave strip lines 18e and 18f and the degree of coupling between the quarter-wave strip lines 18c and 18d can be independently adjusted. More specifically, for the filter 500 described in Japanese Unexamined Patent Application Publication No. 2007-180684, the quarter-wave strip lines 511 and 521 are disposed on the same dielectric layer, and the quarter-wave strip lines 512 and 522 are disposed on the same dielectric layer. Thus, if the number of dielectric layers between the dielectric layer on which the quarter-wave strip lines 511 and 521 are disposed and the dielectric layer on which the quarter-wave strip lines 512 and 522 are disposed is adjusted, the distance between the quarter-wave strip lines 511 and 512 and the distance between the quarter-wave strip lines 521 and 522 are changed. As a result, the degree of coupling between the quarter-wave strip lines 511 and 512 and the degree of coupling between the quarter-wave strip lines 521 and 522 are changed.

In contrast, for the electronic component 10a, the quarter-wave strip line 18c is disposed on the dielectric layer 16e, which is different from the dielectric layer 16d, on which the quarter-wave strip lines 18a and 18e are disposed. Thus, adjusting the number or thickness of dielectric layers 16 disposed between the dielectric layers 16d and 16e enables the distance between the quarter-wave strip lines 18c and 18d to be changed without changing the distance between the quarter-wave strip lines 18a and 18b and that between the quarter-wave strip lines 18e and 18f. Accordingly, the degree of coupling between the quarter-wave strip lines 18a and 18b and that between the quarter-wave strip lines 18e and 18f and the degree of coupling between the quarter-wave strip lines 18c and 18d can be independently adjusted. As a result, the electronic component 10a can be applied to a balance filter having various pass bands.

In adjusting the distance between the quarter-wave strip lines 18e and 18f in the electronic component 10a, it is not necessary to change the pattern of the conductive layers formed on the dielectric layers 16d and 16e. Thus, the electronic component 10a can be applied to a balance filter having various pass bands without incurring additional manufacturing cost.

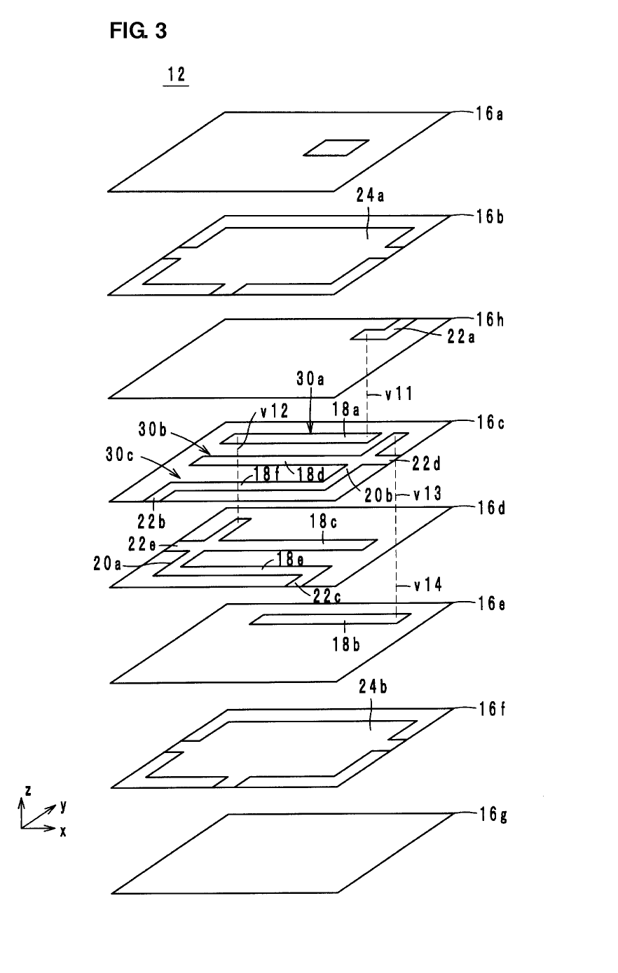

Next, an electronic component according to a first variation of a preferred embodiment of the present invention is described with reference to the drawings. FIG. 3 is an exploded perspective view of the laminated body 12 of an electronic component 10b according to the first variation. FIG. 1 is used as an external perspective view of the electronic component 10b.

In the electronic component 10a, the quarter-wave strip line 18c is disposed on the dielectric layer 16e, which is different from the dielectric layer 16d on which the quarter-wave strip lines 18a and 18e are disposed. In contrast, in the electronic component 10b, the quarter-wave strip line 18b is disposed on the dielectric layer 16e, which is different from the dielectric layer 16d on which the quarter-wave strip lines 18c and 18e are disposed. A configuration of the electronic component 10b is described in detail below. The following description focuses on differences from the electronic component 10a.

In the electronic component 10b, a dielectric layer 16h is disposed between the dielectric layers 16b and 16c. The drawn conductor 22a is disposed on the dielectric layer 16h.

The quarter-wave strip line 18a is disposed on the dielectric layer 16c. A via-hole conductor v11 passes through the dielectric layer 16h along the z-axis direction and connects the drawn conductor 22a and the positive-side end of the quarter-wave strip line 18a in the x-axis direction. A via-hole conductor v12 passes through the quarter-wave strip line 16c in the z-axis direction and connects the negative-side end of the quarter-wave strip line 18a in the x-axis direction and the positive-side end of the connection conductor 20a in the y-axis direction.

The quarter-wave strip line 18c is connected to the connection conductor 20a. The quarter-wave strip line 18d is connected to the connection conductor 20b.

The quarter-wave strip line 18b is disposed on the dielectric layer 16e. Via-hole conductors v13 and v14 pass through the dielectric layers 16c and 16d along the z-axis direction and define one via-hole conductor by being connected to each other. The positive-side end of the via-hole conductor v13 in the z-axis direction is connected to the positive-side end of the connection conductor 20b in the y-axis direction. The negative-side end of the via-hole conductor v14 in the z-axis direction is connected to the positive-side end of the quarter-wave strip line 18b in the x-axis direction.

In the electronic component 10b having the above-described configuration, the quarter-wave strip lines 18c and 18e are disposed on the same dielectric layer 16d. The quarter-wave strip lines 18d and 18f are disposed on the same dielectric layer 16c. The quarter-wave strip line 18b is electrically connected to the quarter-wave strip lines 18d and 18f. The quarter-wave strip line 18a is electrically connected to the quarter-wave strip lines 18c and 18e.

In the electronic component 10b having the above-described configuration, an unbalanced signal is input to the quarter-wave strip line 18a through the external electrode 14a. Then, a balanced signal in the frequency range corresponding to the degree of coupling between the quarter-wave strip lines 18 is output from the quarter-wave strip lines 18e and 18f through the external electrodes 14d and 14f.

For the electronic component 10b, adjusting the number or thickness of dielectric layers 16 disposed between the dielectric layers 16d and 16e enables the distance between the quarter-wave strip lines 18d and 18f to be changed without changing the distance between the quarter-wave strip lines 18c and 18d and that between the quarter-wave strip lines 18e and 18f.

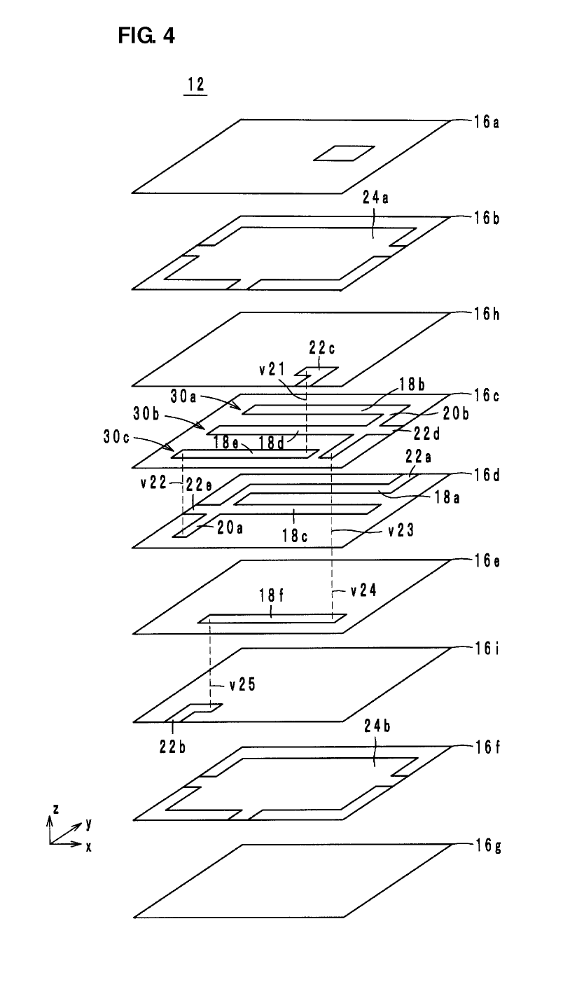

Next, an electronic component according to a second variation of a preferred embodiment of the present invention is described with reference to the drawings. FIG. 4 is an exploded perspective view of the laminated body 12 of an electronic component 10c according to the second variation. FIG. 1 is used as an external perspective view of the electronic component 10c.

In the electronic component 10c, the quarter-wave strip line 18f is disposed on the dielectric layer 16e, which is different from the dielectric layer 16d on which the quarter-wave strip lines 18a and 18c are disposed. A configuration of the electronic component 10c is described in detail below. The following description focuses on differences from the electronic component 10a.

In the electronic component 10c, the dielectric layer 16h is disposed between the dielectric layers 16b and 16c. The drawn conductor 22c is disposed on the dielectric layer 16h.

The quarter-wave strip line 18e is disposed on the dielectric layer 16c. A via-hole conductor v21 passes through the dielectric layer 16h along the z-axis direction and connects the drawn conductor 22c and the positive-side end of the quarter-wave strip line 18e in the x-axis direction. A via-hole conductor v22 passes through the dielectric layer 16c along the z-axis direction and connects the negative-side end of the quarter-wave strip line 18e in the x-axis direction and the negative-side end of the connection conductor 20a in the y-axis direction.

The quarter-wave strip line 18c is connected to the connection conductor 20a. The quarter-wave strip line 18d is connected to the connection conductor 20b.

The quarter-wave strip line 18f is disposed on the dielectric layer 16e. Via-hole conductors v23 and v24 pass through the dielectric layers 16c and 16d along the z-axis direction and define one via-hole conductor by being connected to each other. The positive-side end of the via-hole conductor v23 in the z-axis direction is connected to the negative-side end of the connection conductor 20b in the y-axis direction. The negative-side end of the via-hole conductor v24 in the z-axis direction is connected to the positive-side end of the quarter-wave strip line 18f in the x-axis direction.

A dielectric layer 16i is disposed between the dielectric layers 16e and 16f. The drawn conductor 22b is disposed on the dielectric layer 16i. A via-hole conductor v25 passes through the dielectric layer 16e along the z-axis direction. The positive-side end of the via-hole conductor v25 in the z-axis direction is connected to the negative-side end of the quarter-wave strip line 18f in the x-axis direction. The negative-side end of the via-hole conductor v25 in the z-axis direction is connected to the drawn conductor 22b.

In the electronic component 10c having the above-described configuration, the quarter-wave strip lines 18a and 18c are disposed on the dielectric layer 16d. The quarter-wave strip lines 18b and 18d are disposed on the same dielectric layer 16c. The quarter-wave strip line 18f is electrically connected to the quarter-wave strip lines 18b and 18d. The quarter-wave strip line 18e is electrically connected to the quarter-wave strip lines 18a and 18c.

In the electronic component 10c having the above-described configuration, an unbalanced signal is input to the quarter-wave strip line 18a through the external electrode 14a. Then, a balanced signal in the frequency range corresponding to the degree of coupling between the quarter-wave strip lines 18 is output from the quarter-wave strip lines 18e and 18f through the external electrodes 14d and 14f.

For the electronic component 10c, adjusting the number or thickness of dielectric layers 16 disposed between the dielectric layers 16d and 16e enables the distance between the quarter-wave strip lines 18e and 18f to be changed without changing the distance between the quarter-wave strip lines 18a and 18b and that between the quarter-wave strip lines 18c and 18d.

Electronic components according to the present invention are not limited to the electronic components 10a to 10c according to the above-described preferred embodiments and variations and may be altered within the scope of the present invention.

Each of the electronic components 10a to 10c preferably includes the three resonators 30a to 30c. However, the number of the resonators 30 is not limited to three. The number of the resonators 30 may be any number, for example, two or more than three, as long as it is more than one.

As described above, preferred embodiments of the present invention are useful in an electronic component and, in particular, advantageous in that the degrees of coupling between a plurality of resonators each including a plurality of quarter-wave strip lines can be independently adjusted.

While preferred embodiments of the invention have been described above, it is to be understood that variations and modifications will be apparent to those skilled in the art without departing from the scope and spirit of the invention. The scope of the invention, therefore, is to be determined solely by the following claims.

What is claimed is:

1. An electronic component that converts an unbalanced signal to a balanced signal, the electronic component comprising:
a laminated body including a plurality of dielectric layers stacked in a stacking direction;
a first resonator including a first quarter-wave strip line and a second quarter-wave strip line interdigitally coupled to the first quarter-wave strip line, the first quarter-wave strip line being disposed on one of the plurality of dielectric layers, the second quarter-wave strip line being disposed on another one of the plurality of dielectric layers, the dielectric layer on which the second quarter-wave strip line is disposed being positioned on one side in the stacking direction with respect to the dielectric layer on which the first quarter-wave strip line is disposed; and
a second resonator including a third quarter-wave strip line and a fourth quarter-wave strip line interdigitally coupled to the third quarter-wave strip line, the third quarter-wave strip line being disposed on one of the plurality of dielectric layers, the fourth quarter-wave strip line being disposed on another one of the plurality of dielectric layers, the dielectric layer on which the fourth quarter-wave strip line is disposed being positioned on one side in the stacking direction with respect to the dielectric layer on which the third quarter-wave strip line is disposed; wherein
the first quarter-wave strip line and the third quarter-wave strip line are electromagnetically coupled to each other, and the dielectric layer on which the first quarter-wave strip line is disposed and the dielectric layer on which the third quarter-wave strip line is disposed are different; and
the second quarter-wave strip line and the fourth quarter-wave strip line are electromagnetically coupled to each other.

2. The electronic component according to claim 1, further comprising:
a third resonator including a fifth quarter-wave strip line and a sixth quarter-wave strip line interdigitally coupled to the fifth quarter-wave strip line, the fifth quarter-wave strip line being disposed on one of the plurality of dielectric layers, the sixth quarter-wave strip line being disposed on another one of the plurality of dielectric layers, the dielectric layer on which the sixth quarter-wave strip line is disposed being positioned on one side in the stacking direction with respect to the dielectric layer on which the fifth quarter-wave strip line is disposed; wherein
the third quarter-wave strip line and the fifth quarter-wave strip line are electromagnetically coupled to each other;
the fourth quarter-wave strip line and the sixth quarter-wave strip line are electromagnetically coupled to each other;
the unbalanced signal is input from the first quarter-wave strip line; and
the balanced signal is output from the fifth quarter-wave strip line and the sixth quarter-wave strip line.

3. The electronic component according to claim 2, wherein the dielectric layer on which the first quarter-wave strip line is disposed and the dielectric layer on which the fifth quarter-wave strip line is disposed are the same, and the dielectric layer on which the second quarter-wave strip line is disposed and the dielectric layer on which the sixth quarter-wave strip line is disposed are the same.

4. The electronic component according to claim 3, wherein the third quarter-wave strip line is electrically connected to the second quarter-wave strip line and the sixth quarter-wave strip line, and the fourth quarter-wave strip line is electrically connected to the first quarter-wave strip line and the fifth quarter-wave strip line.

5. The electronic component according to claim 1, further comprising:
a third resonator including a fifth quarter-wave strip line and a sixth quarter-wave strip line interdigitally coupled to the fifth quarter-wave strip line, the fifth quarter-wave strip line being disposed on one of the plurality of dielectric layers, the sixth quarter-wave strip line being disposed on another one of the plurality of dielectric layers, the dielectric layer on which the sixth quarter-wave strip line is disposed being positioned on one side in the stacking direction with respect to the dielectric layer on which the fifth quarter-wave strip line is disposed; wherein
the third quarter-wave strip line and the fifth quarter-wave strip line are electromagnetically coupled to each other;
the fourth quarter-wave strip line and the sixth quarter-wave strip line are electromagnetically coupled to each other;
the unbalanced signal is input from the second quarter-wave strip line; and
the balanced signal is output from the fifth quarter-wave strip line and the sixth quarter-wave strip line.

6. The electronic component according to claim 5, wherein the first quarter-wave strip line is electrically connected to the fourth quarter-wave strip line and the sixth quarter-wave strip line.

7. The electronic component according to claim 5, wherein the second quarter-wave strip line is electrically connected to the third quarter-wave strip line and the fifth quarter-wave strip line.

8. The electronic component according to claim 1, further comprising:
a third resonator including a fifth quarter-wave strip line and a sixth quarter-wave strip line interdigitally coupled to the fifth quarter-wave strip line, the fifth quarter-wave strip line being disposed on one of the plurality of dielectric layers, the sixth quarter-wave strip line being disposed on another one of the plurality of dielectric layers, the dielectric layer on which the sixth quarter-wave strip line is disposed being positioned on one side in the stacking direction with respect to the dielectric layer on which the fifth quarter-wave strip line is disposed; wherein
the first quarter-wave strip line and the fifth quarter-wave strip line are electromagnetically coupled to each other;
the second quarter-wave strip line and the sixth quarter-wave strip line are electromagnetically coupled to each other;
the unbalanced signal is input from the fifth quarter-wave strip line; and
the balanced signal is output from the third quarter-wave strip line and the fourth quarter-wave strip line.

9. The electronic component according to claim 8, wherein the dielectric layer on which the first quarter-wave strip line is disposed and the dielectric layer on which the fifth quarter-wave strip line is disposed are the same, and the dielectric layer on which the second quarter-wave strip line is disposed and the dielectric layer on which the sixth quarter-wave strip line is disposed are the same.

10. The electronic component according to claim 9, wherein the third quarter-wave strip line is electrically connected to the second quarter-wave strip line and the sixth quarter-wave strip line, and the fourth quarter-wave strip line is electrically connected to the first quarter-wave strip line and the fifth quarter-wave strip line.
